(19) United States
(12) Patent Application Publication
(10) Pub. No.: US 2007/0209875 A1
(43) Pub. Date: Sep. 13, 2007

(54) Securing device for extending ladder

(76) Inventor: Mua-Mei Chen, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/372,012

(22) Filed: Mar. 10, 2006

(51) Int. Cl. E06C 1/00

(52) U.S. Cl. 182/195

(57) ABSTRACT

A ladder is composed of a plurality of rung units and each unit includes two hollow tubes and a rung connected between the two hollow tubes. The hollow tubes of the rung units have gradually reduced outer diameters so that the hollow tubes can be telescopically received to form a compact size. The rung is connected to the two hollow tubes of each rung unit by two connectors and each connector includes two buttons which can be pushed to release the interlock connection between the rung and the hollow tubes so as to easily collapse or extend the ladder.

### FIELD OF THE INVENTION

The present invention relates to an extending ladder which includes several rung units and each unit includes two buttons for releasing or securing the two columns relative to another rung unit.

### BACKGROUND OF THE INVENTION

A conventional ladder includes two columns which are usually parallel to each other and rungs are connected between the two columns. The rungs are fixed to the columns so that the ladder is bulky and inconvenient for storage. Two extending ladders are known to applicant and disclosed in U.S. Pat. No. 6,708,800 and U.S. Pat. No. 6,883,645. The two extending ladders require the user to push two thumbs toward a center portion of the ladder to extend or collapse the ladder. If the travel of the movement of the thumbs are too short, then the ladder cannot be extended or collapsed, and this is obviously inconvenient for the users.

The present invention intends to provide a ladder that requires the user to push two buttons to release the interlocking between the rung units which are then easily extended or collapsed.

### SUMMARY OF THE INVENTION

The present invention relates to a ladder which comprises two parallel columns and each column is composed of a plurality of hollow tubes which have gradually reduced outer diameter so that the tubes with small sizes can be telescopically receivable in the tubes with large sizes. Each tube has an upper hole and a lower hole. Each pair of the tubes have a rung connected therebetween and two connectors are connected between two ends of the rung and the two tubes.

Each connector has a mounting ring mounted on a top end of each tube and, an insertion inserted into one of the two ends of the rung. A connection member is connected between the mounting ring and the insertion. The connection member has a through hole is in alignment with the upper hole and communicates with the insertion and the mounting ring. Each insertion has a controller received therein and the controller including a seat and a button. The seat has a biasing member and a locking bar which is biased by the biasing member at one end thereof. The locking bar is inserted into the through hole of the connection member and the upper hole of the tube. A pin transversely extends through the locking bar. The button has a curved head and two tongues extend from an side of the head and extend into the insertion so as to push the locking bar.

The rung has two apertures defined in a side of two ends thereof and the insertions are inserted into the two ends of the rung so that when the locking bars extend through the through holes of the connectors, the upper holes of the two tubes with large size and the lower holes of the tubes with small size, the ladder is extended and established. When the buttons are pushed, tongues shift the pins such that the locking bars are withdrawn from the lower holes of the tubes with small size, and the tubes with small sizes are telescopically received in the tubes of large sizes.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the ladder wherein the hollow tubes are telescopically received each other;

FIG. 2 is a cross sectional view to show a part of the hollow tubes telescopically received each other;

FIG. 3 is an exploded view to show the connectors for connecting the rung and two hollow tubes;

FIG. 4 is an enlarged exploded view to show the connectors for connecting the rung and two hollow tubes;

FIG. 5 is a perspective view to show the connector of the present invention;

FIG. 6 is a top view of the connector of the present invention;

FIG. 7 is a cross sectional view along line A-A in FIG. 6;

FIG. 8 shows a cross sectional view of the connection of the connector and the rung and the hollow tube, wherein the button is not yet pushed;

FIG. 9 is a cross sectional view along line B-B in FIG. 8;

FIG. 10 shows a cross sectional view of the connection of the connector and the rung and the hollow tube, wherein the button is pushed;

FIG. 11 is a cross sectional view along line C-C in FIG. 10;

FIG. 12 is a cross sectional view to show the positions of the locking bars when the tubes are pulled up, and

FIG. 13 is a cross sectional view to show the positions of the locking bars when the tubes telescopically received in each other.

### DETAILED DESCRIPTION OF THE PREFERRED EMBODIMENT

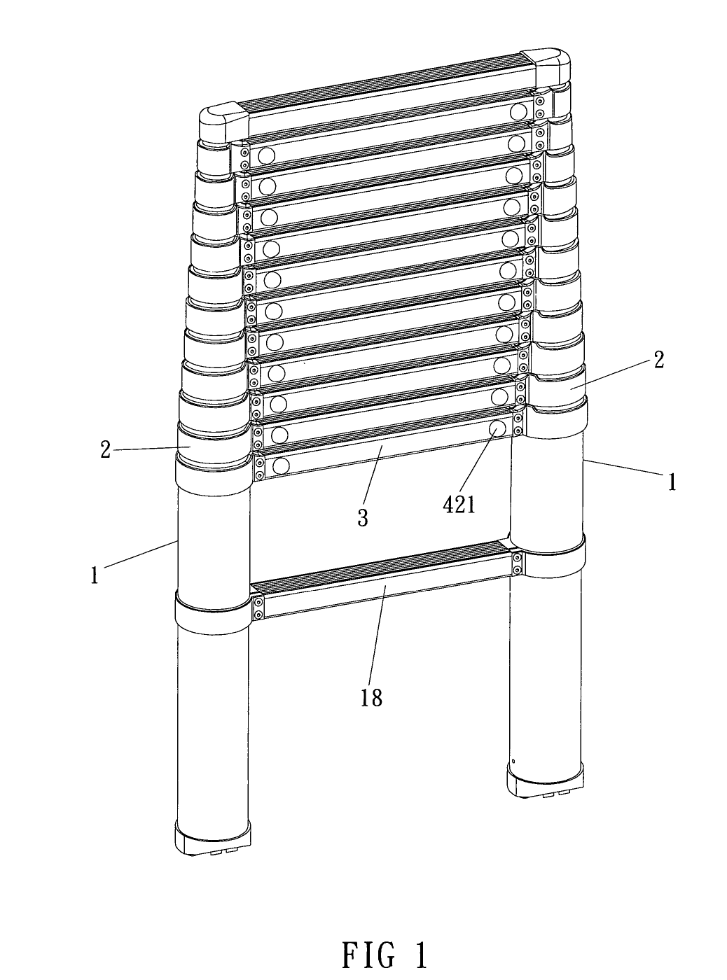

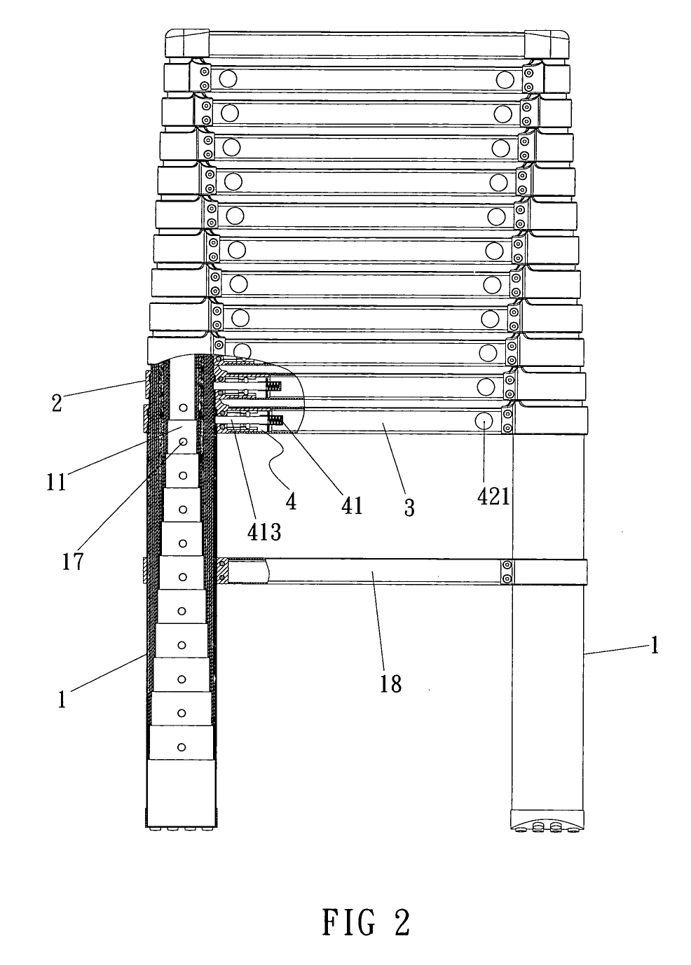

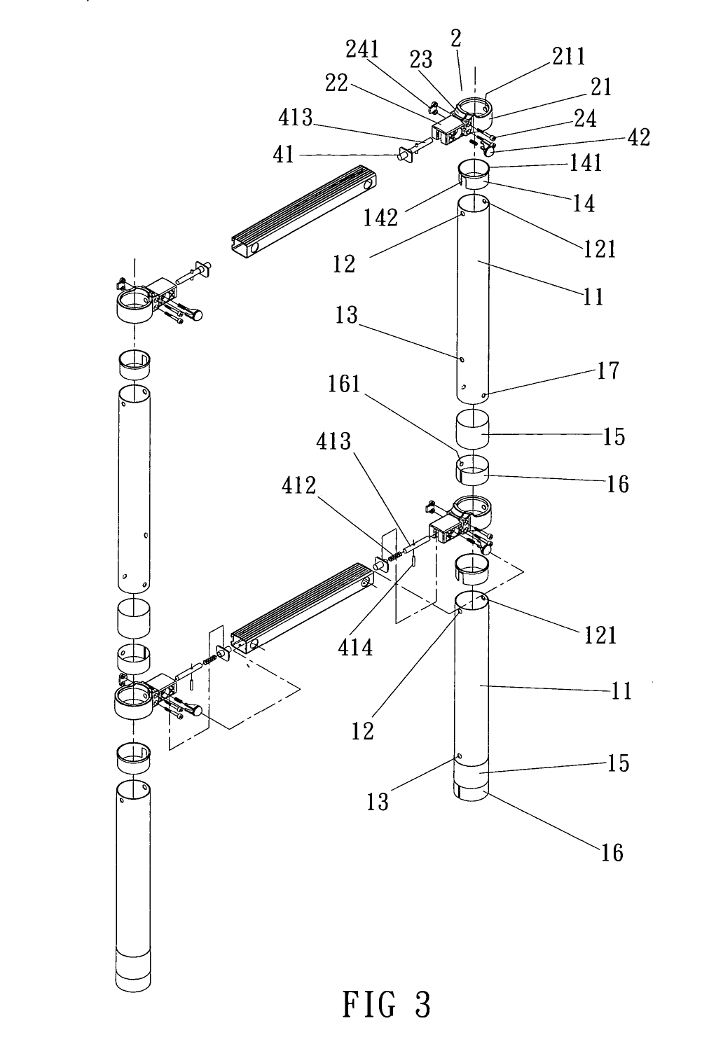

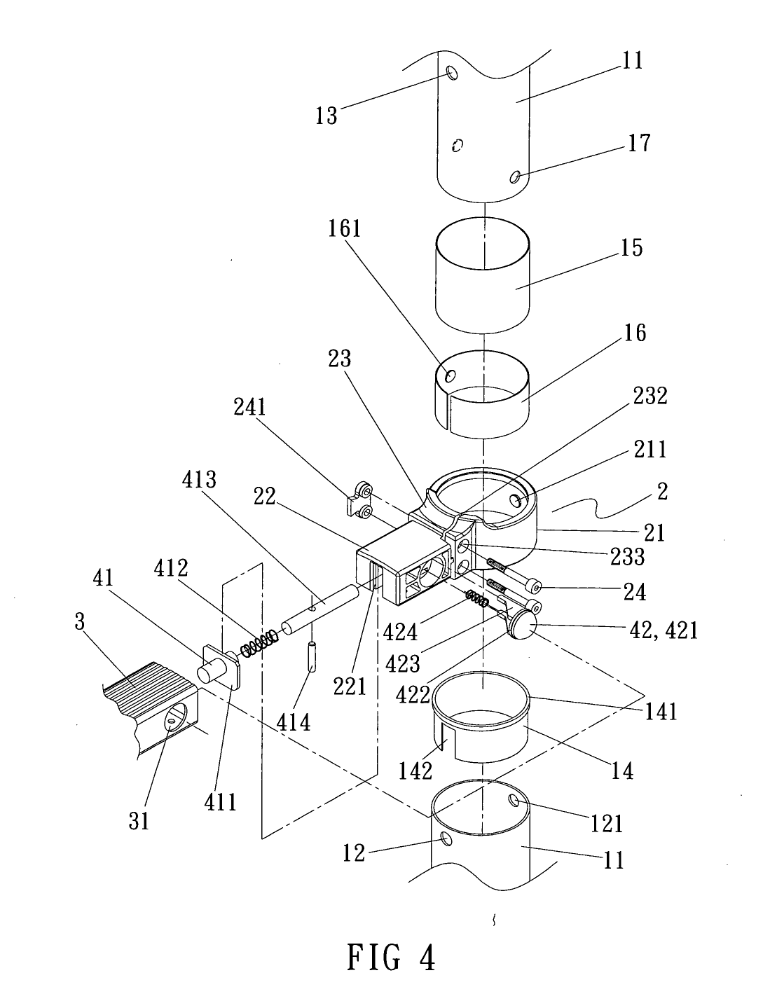

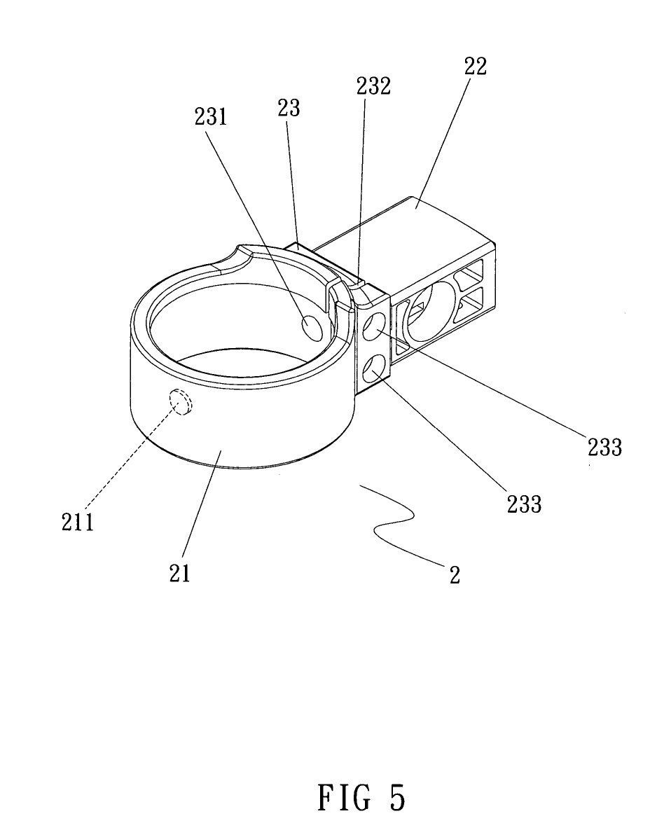

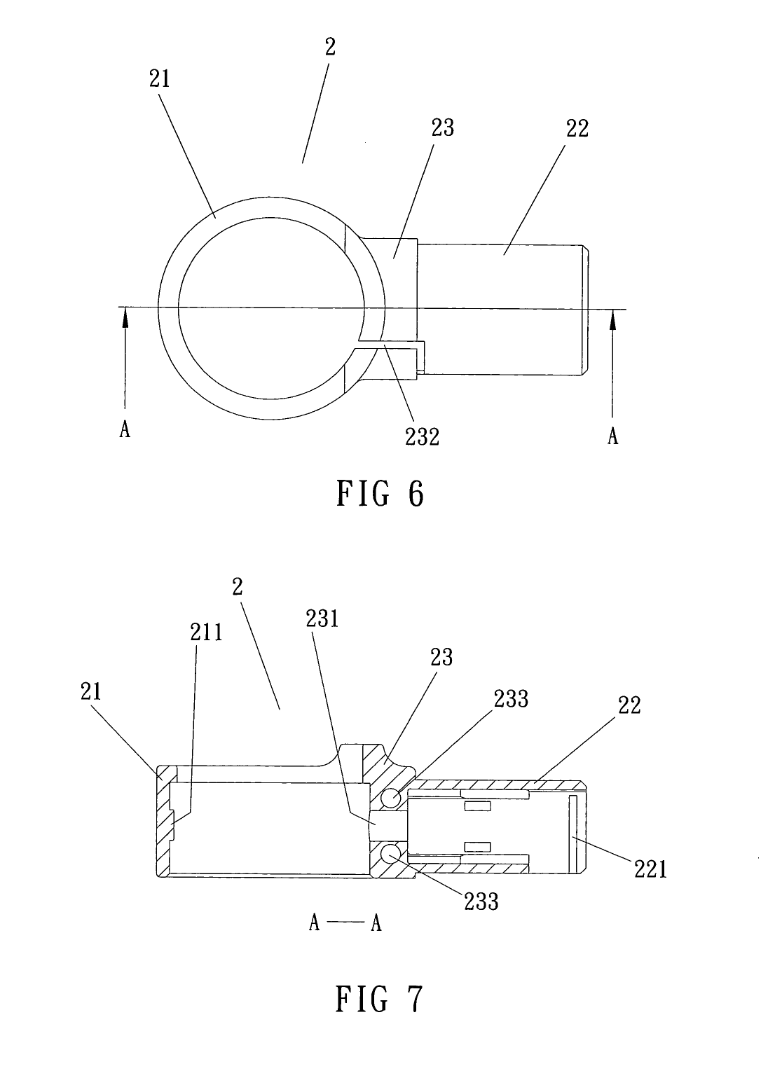

Referring to FIGS. 1 to 7, the ladder of the present invention is composed of composed of a plurality of rung units and each rung unit includes two hollow tubes 11 and a rung 3 connected therebetween. The hollow tubes 11 form two parallel columns 1 and the hollow tubes 11 have gradually reduced outer diameter so that the tubes 11 with small sizes are telescopically receivable in the tubes 11 with large sizes as shown in FIG. 1. Each tube 11 has an upper hole 12 and a lower hole 13 defined through a wall of two ends thereof, and the upper holes 12 and the lower holes 13 in the two respective tubes 11 face each other. Two connectors 2 are connected between two ends of the rung 3 and the two tubes 11. A separation bar 18 is connected between the two tubes 11 with largest sizes to keep a stable width between the two columns 1.

Each connector 2 has a mounting ring 21 and an insertion 22, wherein the mounting ring 21 is mounted on a top end of each tube 11 and the insertion 22 is inserted into one of the two ends of the rung 3. A connection member 23 is connected between the mounting ring 21 and the insertion 22. A through hole 231 is defined in the connection member 23 and in alignment with the upper hole 12 so as to communicate with the insertion 22 and the mounting ring 21. The connection member 23 has an L-shaped slot 232 which communicates with the mounting ring 21. Two passages 233 are defined through the connection member 23 such that the through hole 231 is located between the two passages 233. Two bolts 24 extend through the passages 233 and are connected to a reinforcement plate 241 so that the mounting ring 21 is fixed on the tube 11. Each of the tubes 11 has a positioning hole 121 located close to the top end thereof and the mounting ring 21 has a positioning protrusion 211 extending from an inner periphery thereof so that the positioning protrusion 211 is engaged with the positioning hole 121.

It is noted that each of the tubes 11 has an inner bush 14 inserted in a top end thereof and the inner bush 14 has a flange 141 extending radially outward therefrom so as to be positioned between the mounting ring 21 and the tube 11. The inner bush 14 has a notch 142 which is in alignment with the upper hole 12. Each of the tubes 11 has an outer bush 15 and an outer collar 16 mounted to an outer periphery of a lower end of the tube 11. The outer bush 15 and the outer collar 16 are located between the tube 11 with small size and the tube 11 with large size, and do not block the lower hole 13. Each of the tubes 11 has an engaging hole 17 defined through a wall of the lower end thereof and the outer bush 16 has a boss 161 extending from an inner periphery thereof. The boss 161 is engaged with the engaging hole 17 such that the outer bush 16 is fixed on the tube 11.

Each insertion 22 has a controller 4 received therein and the controller 4 includes a seat 41 and a button 42. The seat 41 includes a board 411, a biasing member 412 received in a box on the board 411 and a locking bar 413 which has one end inserted in the box via an open end of the box and is biased by the biasing member 412 at one end thereof. The board 411 can be inserted in a groove 211 defined in an underside of the insertion 22 so as to be securely connected to the insertion 22. The locking bar 413 is inserted into the through hole 231 of the connection member 23 and the upper hole 12 of the tube 11. A pin 414 transversely extends through the locking bar 413.

The button 42 has a curved head 421 which has a stepped surface 422 and two tongues 423 extend from an side of the head 421 and into the insertion 22. Each of the tongues 423 has an inclined section which pushes the locking bar 413 when the button 42 is pushed. The rung 3 has two apertures 31 defined in a side of two ends thereof and the insertions 22 are inserted into the two ends of the rung 3 and the heads 421 project from the apertures 31. The stepped surface 422 of each button 42 is engaged with an inside of the aperture 31 corresponding thereto.

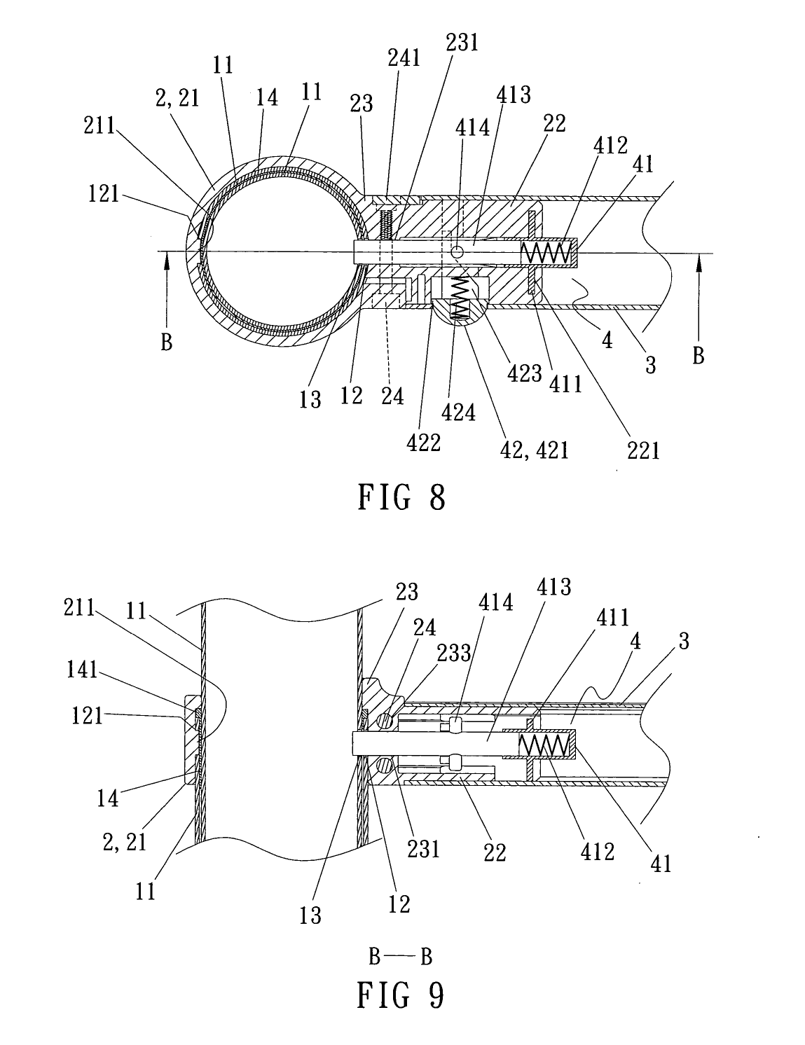

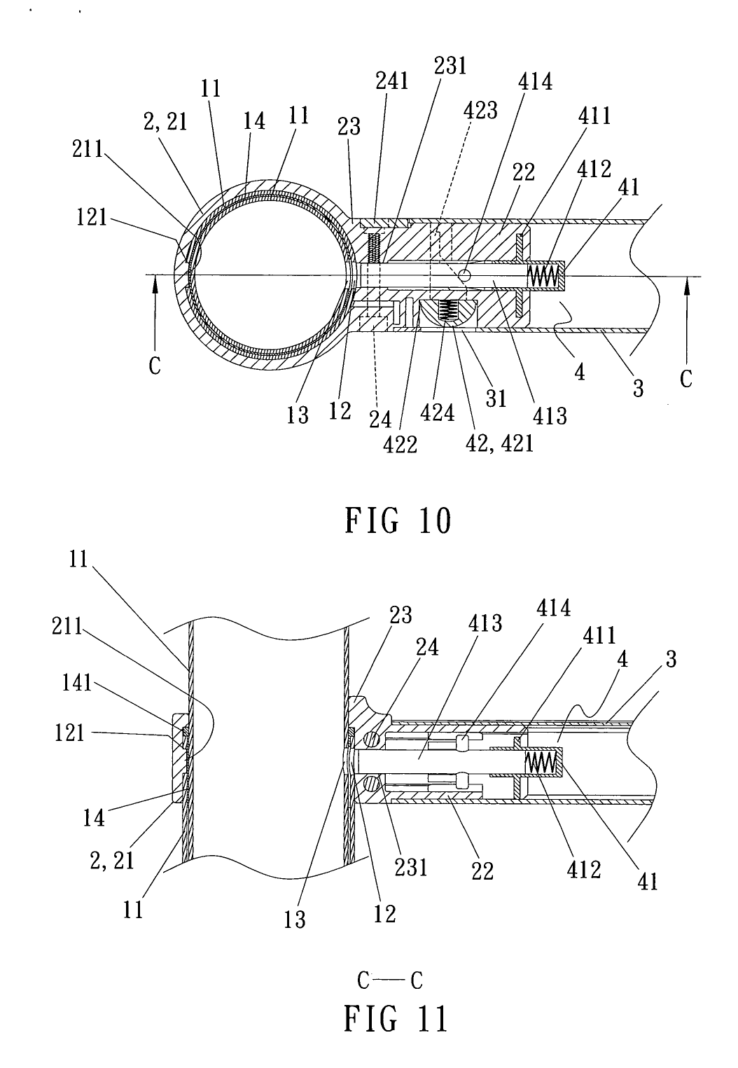

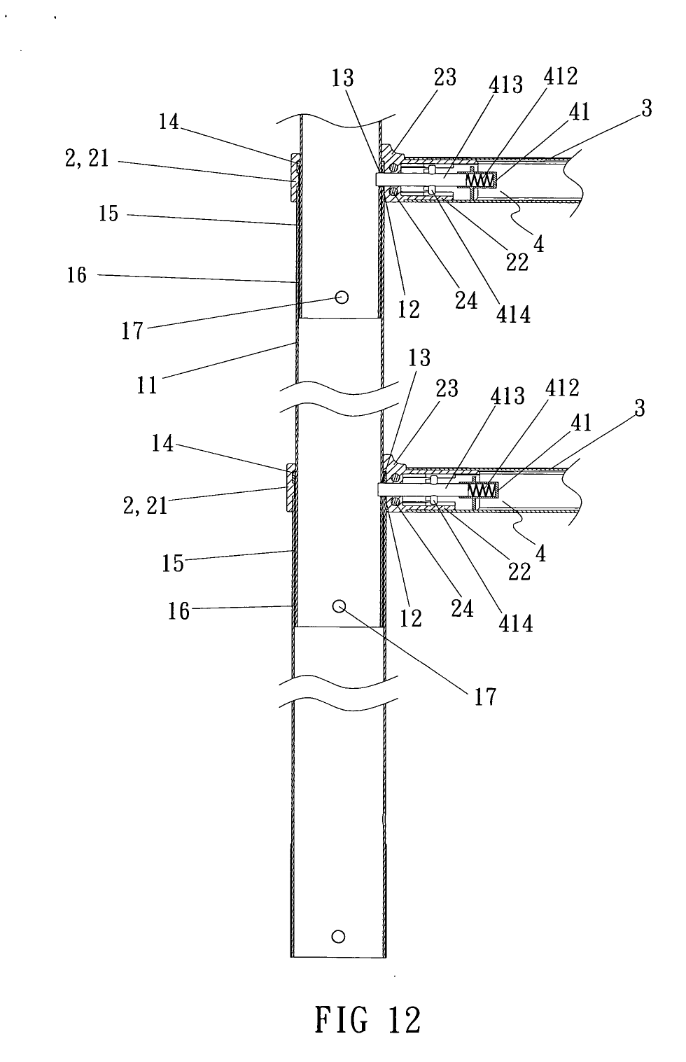

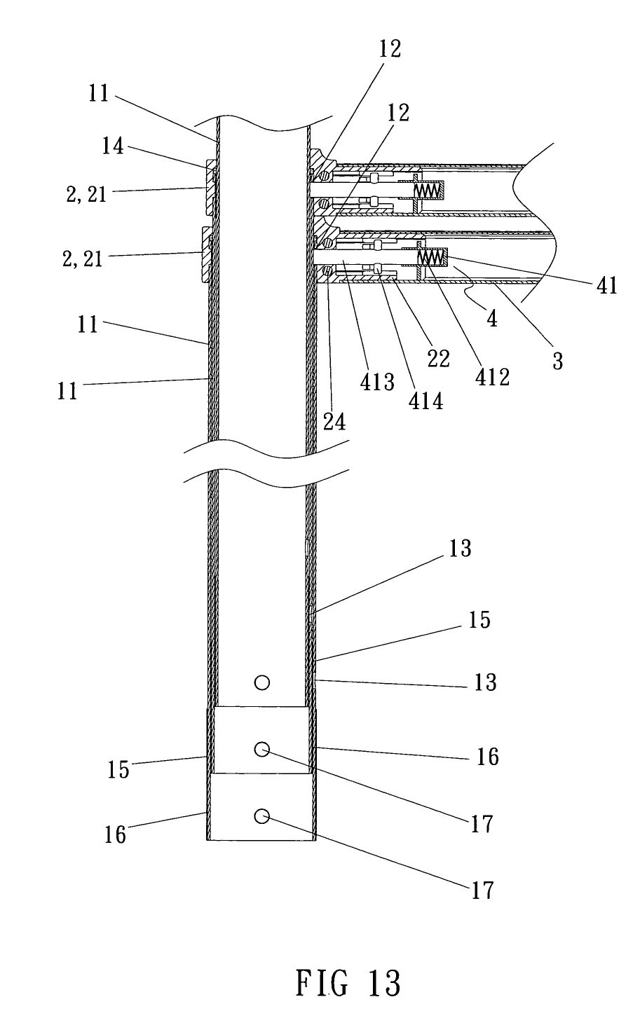

Referring to FIGS. 8-13, when the locking bars 413 extend through the through holes 231 of the connectors 2, the upper holes 12 of the two tubes 11 with large size and the lower holes 13 of the tubes 11 with small size, the ladder is established. On the contrary, when the buttons 42 are pushed and tongues 423 shift the pins 414, the locking bars 413 are withdrawn from the lower holes 13 of the tubes 11 with small size, the tubes 11 with small sizes are telescopically received in the tubes 11 of large sizes. The button 42 of each controller 4 has a second biasing member 424 received in the head 421 so as to bounce the button 42 back to its original position when releasing the buttons 42.

The ladder can be easily collapsed or extended by pushing the two buttons 42 to move the locking bars 413. The tubes 11 can be made by a first material, and the inner bushes 14, the outer bushes 15 and the outer collars 16 can be made by a second material. The first material can be aluminum alloy and the second material can be composite material.

While we have shown and described the embodiment in accordance with the present invention, it should be clear to those skilled in the art that further embodiments may be made without departing from the scope of the present invention.

What is claimed is:

1. A ladder comprising:
two parallel columns and each column composed of a plurality of hollow tubes which have gradually reduced outer diameter so that the tubes with small sizes are telescopically receivable in the tubes with large sizes, each tube having an upper hole and a lower hole defined through a wall of two ends thereof, the upper holes and the lower holes of the tubes of the two columns facing each other, each pair of the tubes having a rung connected therebetween and two connectors connected between two ends of the rung and the two tubes;
each connector having a mounting ring mounted on a top end of each tube and, an insertion inserted into one of the two ends of the rung, a connection member connected between the mounting ring and the insertion, the connection member having a through hole which is in alignment with the upper hole so as to communicate with the insertion and the mounting ring;
each insertion having a controller received therein and the controller including a seat and a button, the seat having a biasing member and a locking bar which is biased by the biasing member at one end thereof, the locking bar inserted into the through hole of the connection member and the upper hole of the tube, a pin transversely extending through the locking bar;
the button having a curved head which has a stepped surface, two tongues extending from an side of the head and extending into the insertion so as to push the locking bar, and
the rung having two apertures defined in a side of two ends thereof, the insertions being inserted into the two ends of the rung and the heads projecting from the apertures, the stepped surface of each button being engaged with an inside of the aperture corresponding thereto;

2. The ladder as claimed in claim 1, wherein each of the tubes has an inner bush inserted in a top end thereof and the inner bush has a flange extending radially outward therefrom so as to be positioned between the mounting ring and the tube, the inner bush has a notch which is in alignment with the upper hole.

3. The ladder as claimed in claim 1, wherein each of the tubes has an outer bush and an outer collar mounted to an outer periphery of a lower end of the tube, the outer bush and the outer collar are located between the tube with small size and the tube with large size, and do not block the lower hole.

4. The ladder as claimed in claim 3, wherein each of the tubes has an engaging hole defined through a wall of the lower end thereof and the outer bush has a boss extending from an inner periphery thereof, the boss is engaged with the engaging hole such that the outer bush is fixed on the tube.

5. The ladder as claimed in claim 1, wherein each of the tubes has a positioning hole located close to the top end thereof, the mounting ring has a positioning protrusion extending from an inner periphery thereof, the positioning protrusion is engaged with the positioning hole.

6. The ladder as claimed in claim 1, wherein the connection member of each of the connectors has an L-shaped slot which communicates with the mounting ring, two passages are defined through the connection member such that the through hole is located between the two passages, two bolts extend through the passages and are connected to a reinforcement plate so that the mounting ring is fixed on the tube.

7. The ladder as claimed in claim 1, wherein the button of each controller has a second biasing member received in the head so as to bounce the button back to its original position.

8. The ladder as claimed in claim 1, wherein a separation bar is connected between the two tubes with largest sizes.

9. The ladder as claimed in claim 1, wherein the tubes are made by a first material, the inner bushes, the outer bushes and the outer collars are made by a second material.

10. The ladder as claimed in claim 1, wherein the first material is aluminum alloy and the second material is composite material.

11. The ladder as claimed in claim 1, wherein the board of the seat includes a box with an open end and the biasing member is received in the box, the end of the locking bar is inserted into the box via the open end and biased by the biasing member.

12. The ladder as claimed in claim 1, wherein a groove is defined in an underside of the insertion and the board is inserted in the groove.
